(19) United States
(12) Patent Application Publication
(10) Pub. No.: US 2026/0166695 A1
(43) Pub. Date: Jun. 18, 2026

(54) METHOD AND DEVICE FOR EXTRACTING PISTON FROM CYLINDER PROVIDED TO CALIPER OF DISK BRAKE

(71) Applicant: Taisyou Ishimura, Hokkaido (JP)

(72) Inventor: Taisyou Ishimura, Hokkaido (JP)

(21) Appl. No.: 19/107,546

(22) PCT Filed: Aug. 21, 2023
(86) PCT No.: PCT/JP2023/029977

§ 371 Date: Jun. 12, 2025

(30) Foreign Application Priority Data
Sep. 1, 2022 (JP) 2022-139397

(51) Int. Cl. B25B 27/00

(52) U.S. Cl. CPC B25B 27/0035

(57) ABSTRACT

A method is provided that enables safe and easy extraction of a piston from a cylinder provided in a caliper while taking environmental issues into consideration by minimizing wasteful leakage and discarding of a brake fluid. This method includes generating pressurized water. The generated pressurized water is supplied into the cylinder while a communication hole is opened that communicates between the outside of the caliper and the inside of the cylinder. The communication hole is closed when the pressurized water is discharged through the communication hole. After the communication hole is closed, the pressurized water is further supplied into the cylinder. The piston is pushed out of the cylinder by means of the pressurized water supplied into the cylinder.

### TECHNICAL FIELD

The present invention relates to a method and a device for extracting a piston from a cylinder provided in a brake caliper in repairing a disc brake of an automobile or the like.

### BACKGROUND ART

Brake fluid used to operate disc brakes of automobiles, motorcycles, and the like contains a hygroscopic component. This may cause a piston to be stuck by rust that occurs between a cylinder and the piston due to moisture generated in the brake fluid or environmental conditions outside the piston. Such a state requires much labor when a stuck piston needs to be removed from the cylinder, for example, for the purpose of repair.

The following methods have been used conventionally to extract a stuck piston from a cylinder.

The most primitive method is to grasp the exposed part of the piston with special pliers or the like, and gradually pull out the piston while rotating it. However, with this method, the sliding resistance between the piston and the cylinder is large in the first place and the two are stuck together, so that it is difficult to easily remove the piston by simply pulling it by hand. Techniques have also been proposed that each use a dedicated tool to remove the piston (for example, Patent Literature 1, Patent Literature 2, and the like).

In some cases, there is a practice of using a method of injecting compressed air into the cylinder through a hole of the removed union bolt (also called banjo bolt) part to push out the piston. This method uses air, which is a compressible fluid, and therefore the piston may swiftly jump out due to the compressed air at high pressure, which may injure the worker or damage the parts. Furthermore, brake fluid remaining in the cylinder may splash out and damage the painted surface of the vehicle body and the like.

Furthermore, there is a method in which the brake hose is reconnected with the caliper removed from the knuckle, and the brake pedal is depressed with a master cylinder filled with brake fluid, thereby removing the piston by the hydraulic pressure of the brake fluid. This method requires work to be carried out near the vehicle, and therefore, when the piston is removed, the brake fluid may damage the painted surface of the vehicle body or contaminate the floor surface during work. In addition, since air is mixed in the brake hose, it is necessary to bleed the air before work, which is cumbersome.

In order to prevent contamination of the working environment by brake fluid, a technique described in Patent Literature 3 has been proposed. This technique is such that a piston pump pumps brake fluid stored in a container and supplies it to a caliper placed on an upper receiving tray that communicates with the container, and removes the piston from the cylinder with hydraulic pressure. The brake fluid having been pumped and the brake fluid remaining in the caliper can be collected in the receiving tray, so that the floor surface is not contaminated by the brake fluid.

The brake fluid having been used is difficult to reuse and must be discarded because it becomes dirty and deteriorates due to moisture in the air and the like. However, the disposal of brake fluid requires a lot of cost and effort. In addition, when the piston is removed, the entire caliper is contaminated with brake fluid, so that the caliper needs to be washed with water or detergent, and the water is also contaminated with brake fluid. Disposal of contaminated water also requires cost and effort.

Furthermore, if the device using this technique is always kept in a state in which the lower container is filled with brake fluid so that the device can be immediately used if necessary, the device is difficult to be moved. Conversely, if the brake fluid is removed each time after use, a dedicated container needs to be separately prepared for that.

### CITATION LIST

### Patent Literature

Patent Literature 1: Japanese Utility Model Laid-Open No. 62-168272
Patent Literature 2: Japanese Patent Laid-Open No. 2007-198454
Patent Literature 3: Japanese Utility Model Laid-Open No. 61-38335

### SUMMARY OF INVENTION

### Technical Problem

In order to solve the above problems, an object of the present invention is to provide a method that enables safe and easy extraction of a piston from a cylinder provided in a brake caliper while taking environmental issues into consideration by minimizing wasteful leakage and discarding of brake fluid, and a portable device for implementing the method.

### Solution to Problem

The present invention provides a piston extraction method for extracting a piston from a cylinder provided in a caliper of a disc brake. This method includes generating pressurized water. The generated pressurized water is supplied into the cylinder while a communication hole is opened that communicates between the outside of the caliper and the inside of the cylinder. The communication hole is closed when the pressurized water is discharged through the communication hole. After the communication hole is closed, the pressurized water is further supplied into the cylinder. The piston is pushed out of the cylinder by means of the pressurized water supplied into the cylinder. When the piston is pushed out of the cylinder, the caliper is preferably placed in water. The pressure of the generated pressurized water is preferably 0.5 MPa to 1.2 MPa, and the pressure of the pressurized water is preferably reduced when the pressure of the pressurized water reaches 1.0 MPa to 1.5 MPa.

The present invention also provides a piston extraction device for extracting a piston from a cylinder provided in a caliper of a disc brake. The device includes: a pressurized water generating unit that generates pressurized water; a pressurized water supply unit that supplies the generated pressurized water from the pressurized water generating unit to a brake hose connection hole that is provided in the caliper and communicates between the inside of the caliper and the outside of the cylinder; and a valve that can be freely opened and closed and is provided in a communication hole communicating between the outside of the caliper and the inside of the cylinder. The pressurized water supply unit of the device preferably has either or both of a pressure control valve and a water pressure gauge. The pressure of the pressurized water generated by the pressurized water generating unit is preferably 0.5 MPa to 1.2 MPa, and the pressure control valve preferably reduces the pressure of the pressurized water when the pressure of the pressurized water reaches 1.0 MPa to 1.5 MPa. In one embodiment, the pressurized water generating unit can have a water tank, a pump that pressurizes the water in the water tank through manual operation, and a filter that removes foreign matter from the water to be supplied to the pump from the water tank.

### Advantageous Effects of Invention

According to the present invention, the piston is extracted using water pressure with the brake fluid drained from the removed caliper, so that the caliper is not contaminated by the brake fluid and the burden on the environment is extremely small. In addition, since the working fluid to be used is incompressible water, the piston does not jump out of the cylinder and can be safely extracted.

### BRIEF DESCRIPTION OF DRAWINGS

FIG. 1 shows a configuration of a piston extraction device for extracting a piston from a cylinder provided in a caliper of a disc brake according to one embodiment of the present invention.

FIG. 2 shows a configuration of a water supply unit of a piston extraction device according to another embodiment of the present invention.

### DESCRIPTION OF EMBODIMENTS

Embodiments of the present invention will be described in detail below with reference to the drawings.

### (Configuration of Piston Extraction Device According to First Embodiment)

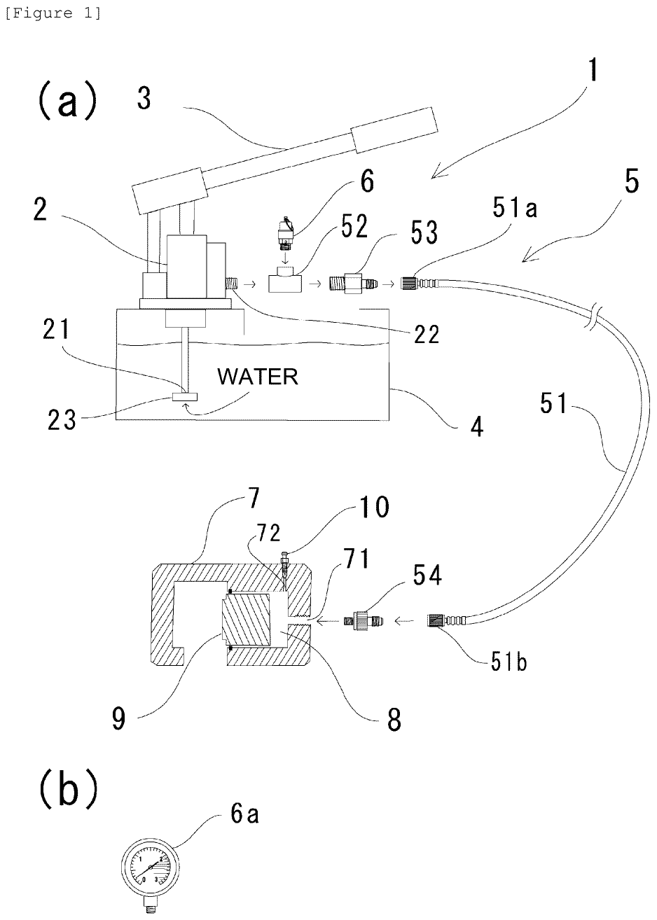

FIG. 1 shows a configuration of a piston extraction device 1 (hereinafter referred to as a device 1) according to a first embodiment of the present invention. The device 1 is for easily extracting a piston from a cylinder provided in a caliper using pressurized water instead of brake fluid with the brake fluid drained from the caliper removed from a vehicle such as an automobile.

The device 1 includes a pump (pressurized water generating unit) 2 that can pressurize water to generate pressurized water. In this embodiment, the pump 2 is a manual pump that can pressurize water by operating its handle 3 up and down. In another embodiment, the pump 2 may be an electric pump. The pump 2 may be any pump capable of pressurizing water to approximately 0.5 MPa to 1.2 MPa.

The device 1 includes a water tank 4 that stores water to be pressurized by the pump 2. The water stored in the water tank 4 enters the pump 2 from a suction port 21 by operating the handle 3 up and down, is pressurized, and is discharged as pressurized water from a discharge port 22. A filter 23 for removing foreign matter contained in the water in the water tank 4 is preferably attached to the suction port 21. A commercially available water pressure test pump used for piping leakage inspection and water resistance inspection can be used as the pump 2, handle 3, and water tank 4 of the device 1 as necessary, thereby providing a compact and inexpensive piston extraction device.

A pressurized water supply unit 5 is connected to the discharge port 22 of the pump 2. The pressurized water supply unit 5 has a flexible hose 51 through which pressurized water passes. One end 51a of the hose 51 can be connected to the discharge port 22 of the pump 2.

Here, in the case in which the pressure generated by the pump 2 is high, the pressure inside the pressurized water supply unit 5 is desirably reduced in order to ensure safety when a pressure is generated that is equal to or higher than a sufficient pressure to generate pressurized water. For this reason, the pressurized water supply unit 5 is preferably provided with a pressure control valve 6 capable of releasing the internal pressure when the pressure of the pressurized water reaches or exceeds a predetermined pressure. Specifically, a T-shaped pipe connector 52 can be placed between the discharge port 22 of the pump 2 and one end 51a of the hose 51, and a pressure control valve 6 can be connected to one of the ports of the connector 52. The pressure control valve 6 is preferably, but not limited to, one configured such that the pressure of the pressurized water is released when it reaches 1.0 MPa to 1.5 MPa.

When a commercially available air conditioner charging hose or the like is used as the hose 51, it is more preferable that one end 51a of the hose 51 and the T-shaped pipe connector 52 be connected by a flare connector 53 produced to fit the end connector of the commercially available hose. When a T-shaped pipe connector 52 and a flare connector 53 are used, these also constitute the pressurized water supply unit 5.

In another embodiment, instead of the pressure control valve 6, a water pressure gauge 6a capable of measuring the internal pressure of the pressurized water supply unit 5 can be placed in the pressurized water supply unit 5. Placing a water pressure gauge 6a can alert the worker that the pressure inside the pressurized water supply unit 5 has reached a pressure sufficient to generate pressurized water or higher. In yet another embodiment, both the pressure control valve 6 and the water pressure gauge 6a can be placed in the pressurized water supply unit 5.

The other end 51b of the hose 51 is connected to a caliper 7 of a brake. Specifically, the other end 51b of the hose 51 is connected to a brake hose connection hole 71 to which a brake hose is connected that primarily supplies brake fluid to the inside of a cylinder 8 provided in the caliper 7. Note that, when a commercially available air conditioner charging hose or the like is used as the hose 51, it is more preferable that the other end 51b of the hose 51 and the brake hose connection hole 71 be connected by a flare connector 54 produced to fit the end connector of the commercially available hose. When a flare connector 54 is used, this also constitutes the pressurized water supply unit 5.

In the embodiment of FIG. 1, the pump 2 and the caliper 7 are connected using a flexible hose 51, but the connection is not limited to this. The discharge port 22 of the pump 2 and the brake hose connection hole 71 of the caliper 7 may be connected using a short pipe. In this case, the pipe forms the pressurized water supply unit 5.

A piston 9, which is the object to be extracted by the device 1, is placed inside the cylinder 8. The caliper 7 is provided with a communication hole 72 that communicates between the outside of the caliper 7 and the inside of the cylinder 8. The communication hole 72 is provided with a valve 10 that can freely open and close the communication hole 72 manually or electrically. The valve 10 is opened when the device 1 is operated, and is closed when pressurized water is discharged from the communication hole 72.

### (Configuration of Piston Extraction Device According to Second Embodiment)

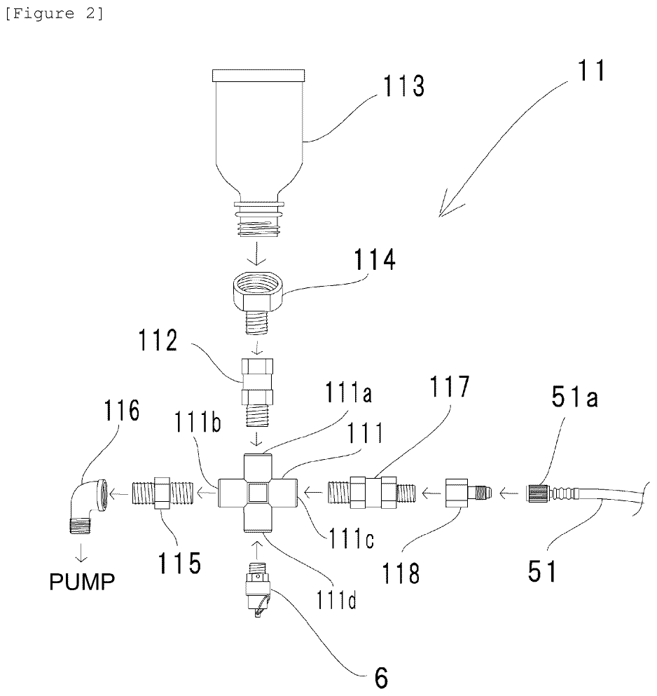

Next, a second embodiment of the present invention will be described. FIG. 2 shows a configuration of a water supply unit 11 of a piston extraction device according to a second embodiment. Note that FIG. 2 does not show the same components as FIG. 1, except for some.

In the first embodiment, the water to be pressurized by the pump 2 is stored in the water tank 4. In contrast, in the second embodiment, the water to be pressurized is not stored in the water tank 4 but can be supplied to the pump 2 from a removable water supply tank 113. In the first embodiment, it is necessary to fill the water tank 4 with water from a water faucet or the like and carry the heavy device 1 to the work site. In contrast, in the second embodiment, the pump 2 and an empty water tank 4 are placed at the work site, and the water supply tank 113 filled with water can be carried to the work site and attached to the pump 2, or water can be supplied to the empty water supply tank 113 attached to the pump 2 using a hose, making the work easier.

The water supply unit 11 has a four-way connector 111. A check valve 112 is connected to one port 111a (the upper port in FIG. 2) of the four-way connector 111. A water supply tank 113 is further connected to the check valve 112. The check valve 112 is configured to allow water to flow only in the direction from the water supply tank 113 toward the four-way connector 111. If necessary, for example, in order that a ready-made PET bottle is allowed to be attached instead of the water supply tank 113, a connector 114 with one port corresponding to a PET bottle may be interposed between the check valve 112 and the water supply tank 113.

If necessary, another port 111b (the left port in FIG. 2) of the four-way connector 111 is connected to the discharge port 22 of the pump 2 through an L-shaped connector 116. If necessary, another connector 115 may be placed between the four-way connector 111 and the L-shaped connector 116. Using the L-shaped connector 116 prevents the water supply tank 113 from interfering with the operation of the pump 2 when the pump 2 is manual.

A check valve 117 is connected to yet another port 111c (the right port in FIG. 2) of the four-way connector 111. A hose 51 of the pressurized water supply unit 5 is further connected to the check valve 117. The check valve 117 allows water to flow only in the direction from the four-way connector 111 toward the hose 51. If necessary, another connector 118 may be placed between the check valve 117 and the hose 51. A pressure control valve 6 can be connected to yet another port 111d (the lower port in FIG. 2) of the four-way connector 111.

To describe the flow of water in the second embodiment, in the case of a manual pump 2, when the inside of the pump 2 becomes negative pressure due to the operation of the pump 2, water is first supplied from the water supply tank 113 to the pump 2 through the check valve 112 and the four-way connector 111 (from port 111a toward port 111b). Here, the suction port 21 of the pump 2 is closed. The water supplied to the pump 2 is pressurized by pushing down the handle 3, and then discharged from the discharge port 22 and enters the four-way connector 111 from the port 111b. However, since the check valve 112 is connected to the port 111a, the water does not flow toward the water supply tank 113, and flows toward the hose 51 through the check valve 117. When pressurized water is discharged from the discharge port 22 and supplied to the hose 51, the four-way connector 111, the check valve 117, and the connectors 115 and 118 that are connected as necessary function as a pressurized water supply unit.

Next, when the handle 3 is pulled up and the inside of the pump 2 becomes negative pressure, the pressurized water does not return from the hose 51 toward the four-way connector 111 since the check valve 117 is connected, and water from the water supply tank 113 is supplied to the pump 2 through the check valve 112 and the four-way connector 111 in the same manner as described above. In this manner, the water in the water supply tank 113 is pressurized and supplied to the caliper 7 as pressurized water.

### (Method for Using Piston Extraction Device)

Next, a method for using the device 1 will be described based on the first embodiment. First, the caliper 7 is removed from the vehicle, and brake fluid remaining inside the cylinder 8 of the removed caliper 7 is removed. The device 1 is prepared, and a T-shaped pipe connector 52 is connected to the discharge port 22 of the pump 2, and a flare connector 53 is further connected to the T-shaped pipe connector 52 as necessary. One end 51a of the hose 51 is connected to the flare connector 53. If necessary, a flare connector 54 is connected to the other end 51b of the hose 51, and the flare connector 54 is connected to the brake hose connection hole 71 of the caliper 7. The valve 10 of the communication hole 72 of the caliper 7 is left open.

After the device 1 is set up in this manner, the water tank 4 is filled with water and the handle 3 is operated. By operating the handle 3, water in the water tank 4 enters the pump 2 from the suction port 21 through the filter 16, is pressurized, and is discharged from the discharge port 22 as pressurized water. The discharged pressurized water is supplied into the cylinder 8 through the T-shaped pipe connector 52, the flare connector 53, the hose 51, and the flare connector 54.

Here, when the pump 2 is operated for the first time, there is air inside the cylinder 8, and air is further supplied into the cylinder 8 from the hose 51. Since the valve 10 of the communication hole 72 is initially open, the air inside the cylinder 8 and the air supplied from the hose 51 are discharged to the outside of the caliper 7 through the communication hole 72. As the pump 2 continues to operate, pressurized water is supplied from the hose 51 into the cylinder 8, and when the inside of the cylinder 8 is filled with pressurized water, water begins to be discharged from the communication hole 72. When this state is reached, the valve 10 of the communication hole 72 is closed. The reason why the valve 10 is kept open until water is discharged from the communication hole 72 is that air may remain inside the hose 51 or the cylinder 8 until the water is discharged, and if pressurized water is supplied while air remains, the piston 9 may swiftly jump out due to the compressed air at high pressure, which may injure the worker or damage the parts.

If the pump 2 continues to operate after the valve 10 is closed, the pressure inside the cylinder 8 gradually increases, and the pressure of the pressurized water acts on the piston 9. As the pump 2 continues to operate, the piston 9 is pushed out of the cylinder 8 when the pressure of the pressurized water discharged from the pump 2 reaches approximately 0.5 MPa to 1.2 MPa. Even the piston 9 firmly stuck to the cylinder 8 due to rust can be easily pushed out with the pressurized water pressure of a maximum of 2 MPa, so that the work can be completed safely in a short time.

If the piston 9 does not come out of the cylinder 8 even when the pump 2 continues to operate, the pressure control valve 6 provided in the T-shaped pipe connector 52 can open to release the internal pressure, allowing safe work. The pressure at which the pressure control valve 6 opens is not limited, but is preferably 1.0 MPa to 1.5 MPa. If a water pressure gauge 6a is provided separately from or together with the pressure control valve 6, the work can be carried out while the indication of the water pressure gauge 6a is checked, and the operation of the pump 2 can be stopped when the pressure reaches 1.0 MPa to 1.5 MPa.

If there is a small amount of air remaining inside the cylinder 8, the piston 9 may violently jump out of the cylinder 8 when it is removed. Accordingly, placing the caliper 7 in water can further improve the safety of the work. The timing for placing the caliper 7 in water is not limited, but is preferably after the water starts to be discharged from the communication hole 72 and the valve 10 of the communication hole 72 is closed.

### REFERENCE SIGNS LIST

1 piston extraction device
2 pump
21 suction port
22 discharge port
23 filter
3 handle
4 water tank
5 pressurized water supply unit
51 hose
51a one end
51b other end
52 T-shaped pipe connector
53, 54 flare connector
6 pressure control valve
6a water pressure gauge
7 caliper
71 brake hose connection hole
72 communication hole
8 cylinder
9 piston
10 valve
11 water supply unit
111 four-way connector
112 check valve
113 water supply tank
114, 115, 118 connector
116 L-shaped connector
117 check valve

1. A piston extraction method for extracting a piston from a cylinder provided in a caliper of a disc brake, the method comprising:
a step of generating pressurized water;
a step of supplying the generated pressurized water into the cylinder while a communication hole is opened that communicates between an outside of the caliper and an inside of the cylinder;
a step of closing the communication hole when the pressurized water is discharged from the communication hole;
a step of further supplying the pressurized water into the cylinder; and
a step of pushing the piston out of the cylinder by the pressurized water supplied into the cylinder.

2. The piston extraction method according to claim 1, wherein the step of pushing the piston out of the cylinder by the pressurized water supplied into the cylinder is performed with the caliper placed in water.

3. The piston extraction method according to claim 1, wherein a pressure of the pressurized water generated in the step of generating pressurized water is 0.5 MPa to 1.2 MPa.

4. The piston extraction method according to claim 1, further comprising a step of reducing a pressure of the pressurized water when a pressure of the pressurized water reaches 1.0 MPa to 1.5 MPa.

5. The piston extraction method according to claim 1, further comprising a step of removing the caliper from a vehicle and removing brake fluid remaining inside the cylinder.

6. A piston extraction device for extracting a piston from a cylinder provided in a caliper of a disc brake, the device comprising:
a pressurized water generating unit that generates pressurized water;
a pressurized water supply unit that supplies generated pressurized water from the pressurized water generating unit to a brake hose connection hole that is provided in the caliper and communicates between an inside of the caliper and an outside of the cylinder; and
a valve that can be freely opened and closed and is provided in a communication hole that communicates between an outside of the caliper and an inside of the cylinder.

7. The piston extraction device according to claim 6, wherein the pressurized water supply unit has either or both of a pressure control valve and a water pressure gauge.

8. The piston extraction device according to claim 7, wherein the pressure control valve reduces a pressure of the pressurized water when a pressure of the pressurized water reaches 1.0 MPa to 1.5 MPa.

9. The piston extraction device according to claim 6, wherein a pressure of pressurized water generated by the pressurized water generating unit is 0.5 MPa to 1.2 MPa.

10. The piston extraction device according to claim 6, wherein the pressurized water generating unit includes a water tank, a pump that is manually operated to pressurize water in the water tank, and a filter that removes foreign matter from water to be supplied from the water tank to the pump.
